(19) United States
(12) Patent Application Publication
(10) Pub. No.: US 2005/0058882 A1
(43) Pub. Date: Mar. 17, 2005

(54) Anode for liquid fuel cell

(76) Inventors: Vladimir Meiklyar, Jerusalem (IL); Gennadi Finkelshtain, Shoham (IL); Yuri Katsman, Hadera (IL)

Correspondence Address: GREENBLUM & BERNSTEIN, P.L.C., 1950 ROLAND CLARKE PLACE, RESTON, VA, 20191, US

(21) Appl. No.: 10/634,806

(22) Filed: Aug. 6, 2003

(51) Int. Cl. H01M 4/90; H01M 4/88; H01M 4/96; B01J 23/75; H01M 8/20

(52) U.S. Cl. 429/44; 502/101; 502/325; 429/105

(57) ABSTRACT

An anode which is suitable for use in a liquid fuel cell and comprises metallic cobalt supported on a finely divided electrically conductive carrier. An oxidation catalyst for use in the anode, a process for making the oxidation catalyst and a fuel cell comprising the anode are also disclosed. This abstract is neither intended to define the invention disclosed in this specification nor intended to limit the scope of the invention in any way.

### BACKGROUND OF THE INVENTION

1. Field of the Invention

The present invention relates to a cobalt containing anode for a liquid fuel cell and a fuel cell comprising same. The invention also relates to an oxidation catalyst suitable for use in such an anode and to a process for the preparation thereof.

2. Discussion of Background Information

An electrochemical liquid fuel cell (fuel element) is a device that converts the energy of a chemical reaction into electricity. Among the advantages that fuel cells have over other sources of electrical energy are a high efficiency and environmental friendliness. A fuel cell produces electricity by bringing a fuel into contact with a catalytic anode while bringing an oxidant into contact with a catalytic cathode. When in contact with the anode, the fuel is oxidized at catalytic centers to produce electrons. The electrons travel from the anode to the cathode through an electrical circuit connecting the electrodes. Simultaneously, the oxidant is catalytically reduced at the cathode, consuming the electrons generated at the anode. Mass balance and charge balance are preserved by the corresponding production of ions at either the cathode or the anode and the diffusion of these ions to the other electrode through an electrolyte with which the electrodes are in contact. One of the drawbacks of conventional fuel cells in general is their cost of manufacture and, in particular, the high price of the raw materials for the oxidation/reduction catalysts used in the anode/cathode thereof. These catalysts usually are based on expensive metals such as platinum and gold. It would, therefore, be beneficial to have available a relatively inexpensive catalyst for an electrode of a liquid fuel cell with which satisfactory discharge characteristics and electrical output can be achieved without having to rely on the presence of noble metals.

### SUMMARY OF THE INVENTION

The present invention provides an anode suitable for use in a liquid fuel cell, which anode comprises metallic cobalt supported on a finely divided electrically conductive carrier.

In one aspect, the anode is substantially free of noble metals. In another aspect, the anode further comprises up to a maximum of about 40% by weight of at least one additional metal, based on the combined weight of all metals present. This at least one other metal may comprise a transition metal and/or a rare earth metal.

In yet another aspect, the electrically conductive carrier comprises carbon. In a further aspect, the carrier has a specific surface area of at least about 20 m²/g and/or a particle size of not higher than about 30 μm, in particular, not higher than about 20 μm.

In another aspect, the metallic cobalt has been deposited on the carrier by reducing a cobalt salt in the presence of the carrier.

In still another aspect, the concentration of cobalt is from about 0.5 to about 40 weight percent, based on the combined weight of cobalt plus carrier.

In another aspect, the metallic cobalt comprises a cobalt containing alloy. The cobalt containing alloy may comprise one or more other metals selected from transition metals, rare earth metals, Al and Mg. In yet another aspect, the cobalt containing alloy may comprise at least about 1 mol-% of cobalt.

In another aspect, the anode is capable of providing, in an alkaline fuel cell, a current density of at least about 100 mA/cm², e.g., at least about 200 mA/cm², and/or a power of at least about 50 mW/cm², e.g., at least about 70 mW/cm², at a cathode/anode potential difference of 0.55 V and within a temperature range from about 10° C. to about 65° C.

According to another aspect of the anode of the present invention, the anode has a surface area of about 0.5 cm² to about 200 cm².

The present invention also provides a process for making an oxidation catalyst suitable for use in an anode as set forth above. This process comprises the addition of an at least about 3-fold stoichiometric excess of a reducing agent to an aqueous solution of a cobalt(II) compound in the presence of an electrically conductive carrier having a specific surface area of at least about 50 m²/g. In this process, the addition rate of the reducing agent is such that it provides an average particle size of the resultant metallic cobalt of not higher than about 30 nm.

In one aspect of the process, the cobalt(II) compound comprises a Co(II) salt such as, e.g., Co(II) nitrate (including hydrates thereof) and/or the reducing agent comprises a borohydride salt. The borohydride salt may comprise an alkali metal borohydride such as, e.g., sodium borohydride. The reducing agent may be in the form of an aqueous solution and the pH of this solution may be from about 9 to about 12 and/or such that the pH of the reaction mixture following the complete addition of the reducing agent is about 1 to about 12. For example, the solution may comprise an alkali metal hydroxide. Also, the concentration of the reducing agent in the aqueous solution may be about 0.1 to about 1 molar.

In another aspect of the process, the stoichiometric excess of the reducing agent is at least about 10-fold.

In a still further aspect, the electrically conductive carrier comprises carbon. In another aspect, the carbon has a specific surface area of at least about 100 m²/g.

In another aspect, the cobalt compound is present in the aqueous solution prior to adding the reducing agent at a concentration of from about 0.01 mol/l to about 0.5 mol/l and/or the electrically conductive carrier is present in an amount which results in a concentration of the cobalt of about 0.5 to about 40 weight percent, based on the combined weight of cobalt plus carrier.

In another aspect, the process is carried out within a temperature range of form about 10° C. to about 70° C.

In a further aspect, the process is carried out in the substantial absence of noble metals. Furthermore, the process may be carried out in the additional presence of a compound of at least one metal different from cobalt, and the weight ratio of cobalt and the at least one metal different form cobalt is not lower than about 0.005:1.

In yet another aspect, the process further comprises filtering the catalyst, rinsing it with water and drying it. For example, the catalyst may be dried at a temperature of about 60° C. to about 120° C. and/or for a period of about 0.5 hours to about 24 hours.

The present invention furthermore provides an oxidation catalyst which is obtainable by the process set forth above, including the various aspects of this process.

The present invention additionally provides an oxidation catalyst suitable for use in an anode of a liquid fuel cell. This catalyst comprises metallic cobalt supported on an electrically conductive carrier having a specific surface area of at least about 20 m²/g in a concentration of the metallic cobalt of about 0.5 to about 40 weight percent, based on the combined weight of cobalt plus carrier.

In one aspect thereof, the catalyst is substantially free of noble metals. In another aspect, the catalyst further comprises up to a maximum of about 40% by weight of at least one additional metal, based on the combined weight of all metals present. The at least one other metal may comprise a transition metal and/or a rare earth metal.

In another aspect of the catalyst, the carrier comprises carbon and/or the carrier has an average particle size of not higher than about 30 μm.

The present invention further provides a process for making an anode suitable for use in a liquid fuel cell. This process comprises mixing the oxidation catalyst set forth above, including the various aspects thereof, with water, a lower alcohol and a binder to form a paste. The lower alcohol may comprise isopropanol and/or the binder may comprise polytetrafluoroethylene.

In one aspect, the process further comprises applying the paste on carbon paper. The carbon paper with the paste thereon may be combined under pressure with a current collector, for example, a current collector which comprises a metal grid, e.g., a nickel grid.

The present invention also provides a fuel cell comprising a cathode and an anode. The anode comprises the anode set forth above, including the various aspects thereof.

In one aspect of the fuel cell, the cathode comprises an air-breathing cathode.

In another aspect, the fuel cell further comprises a liquid fuel and/or a liquid electrolyte. The liquid fuel may comprise a borohydride salt. By way of non-limiting example, it may comprise an alkali metal borohydride such as, e.g., sodium borohydride. In yet another aspect, the liquid fuel may comprise a solvent and an oxidizable material, e.g., wherein the oxidizable material is both dissolved and dispersed in the solvent. In one aspect, the solvent comprises water and/or the oxidizable material comprises LiAlH₄, NaBH₄, KBH₄, LiBH₄, (CH₃)₃NHBH₃, NaAIH₄, NaCNBH₃, CaH₂, LiH, NaH, KH, Na₂S₂O₃, Na₂HPO₃, Na₂HPO₂, K₂S₂O₃, K₂HPO₃, K₂HPO₂, NaCOOH, KCOOH or any combination of two or more thereof. By way of non-limiting example, the oxidizable material may comprise NaBH₄. In another aspect, the liquid fuel further comprises a monohydric or polyhydric alcohol such as, for example, methanol, ethanol, propanol, isopropanol, butanol, pentanol, hexanol, ethylene glycol, propylene glycol, glycerol or any combination of two or more thereof, e.g., methanol and/or glycerol.

In another aspect, the liquid electrolyte of the fuel cell has a pH of higher than about 7. By way of non-limiting example, it may comprise water and a basic compound. The basic compound may comprise a hydroxide, e.g., an alkali metal hydroxide. Non-limiting examples of the alkali metal comprise Na and K. In yet another aspect, the basic compound is present in the liquid electrolyte at a concentration of about 0.1 to about 5 mol/l.

The present invention furthermore provides an electrical device, e.g., a portable device, which is in electrical contact with the fuel cell set forth above, including the various aspects thereof, as well as a method of powering an electrical device. The method comprises establishing electrical contact between the device and the fuel cell set forth above, including the various aspects thereof.

As discussed above, the anode according to the present invention comprises cobalt in metallic form which is supported (e.g., deposited) on a finely divided, electrically conductive carrier. One of the advantages associated with this anode is that even without inclusion of noble metals (Pt, Pd, Ru, Rh, Au, Ag), it provides highly satisfactory electrical (discharge) characteristics when used as an anode in a liquid fuel cell, in particular, a fuel cell using an alkaline liquid fuel. Accordingly, the anode of the present invention is preferably substantially free of noble metals. The term “substantially free” indicates that the anode may contain trace amounts of noble metals, e.g., less than about 1% by weight, or even less than about 0.1% by weight (e.g., less than about 0.01% by weight), based on the total weight of all metals present in the anode.

It will be appreciated that in addition to cobalt, the anode may comprise one or more other non-noble metals. These metals may be present in an amount of up to about 40% by weight, e.g., up to about 25% by weight, up to about 10% by weight, up to about 5% by weight, or up to about 2% by weight, based on the total weight of all metals present. Non-limiting examples of metals which may be present in addition to cobalt are transition metals (in particular, one or more of Y, Ti, Zr, Hf, V, Nb, Ta, Cr, Mo, W, Mn, Fe, Ni, Cu, Zn and Cd), rare earth metals (=lanthanides) (in particular, one or more of La, Ce, Pr, Nd, Pm, Sm, Eu, Gd, Tb, Dy, Ho, Er, Tm, Yb and Lu) and main group metals such as Al and Mg. These metals may be present individually and in any combination of two or more thereof. They may be present as physical mixture with cobalt and/or they may be present in the from of an alloy which includes cobalt. A corresponding alloy will usually contain at least about 1 mol-%, e.g., at least about 2 mol-%, at least about 5 mol-%, at least about 10 mol-%, at least about 20 mol-%, at least about 50 mol-%, at least about 75 mol-%, or at least about 90 mol-%, of cobalt. Preferred elements for use in such an alloy with cobalt are nickel, molybdenum, ytterbium and combinations thereof. By way of non-limiting example, alloys having the general formula COₓM_{1-z}Yb_{y} wherein M represents Ni and/or Mo, x is in the range from greater than 0 to about 0.5 and y is in the range from 0 to about 0.05 may be used in the present invention.

The electrically conductive carrier for supporting the metallic cobalt (as such and/or in the form of an alloy) and any other metal that may optionally be present will usually have a specific surface area (as determined by the BET method using nitrogen gas) of at least about 20 m²/g, e.g., at least about 50 m²/g, at least about 100 m²/g, at least about 200 m²/g or even at least about 250 m²/g. There is no particular upper limit for the specific surface area, but apparently with increasing specific surface area of the support the handling of the support will become more difficult (e.g., due to its increasingly pyrophoric properties). In view thereof, the specific surface area of the carrier will usually not be higher than about 400 m²/g.

The electrically conductive carrier will usually have a particle size (as determined by, e.g., sieving) of not higher than about 30 μm, e.g., not higher than about 25 μm, not higher than about 20 μm, or not higher than about 10 μm. A preferred electrically conductive carrier for the purposes of the present invention is carbon, although it will be apparent to those skilled in the art that other electrically conductive carriers can be used as well.

The relative proportions of carrier and metallic cobalt can vary over a wide range, although it is preferred that the amount of carrier is equal to at least that amount that is necessary for supporting all of the metallic cobalt (as well as any additional metals that may be present). Based on the combined weight of cobalt plus carrier, the cobalt will usually be present at a concentration of at least about 0.5% by weight, e.g., at least about 1% by weight, at least about 2% by weight, at least about 3% by weight, at least about 5% by weight, but usually not more than about 40% by weight, e.g., not more than about 30% by weight, not more than about 25% by weight, not more than about 20% by weight, not more than about 15% by weight, or not more than about 10% by weight. If cobalt is present in combination with other metals (e.g., in the form of an alloy), the above percentages apply to the total amount of all metals present. In other words, based on the combined weight of all metals plus carrier, the combined metals usually will account for at least about 0.5% by weight, but for not more than about 40% by weight.

A suitable process for making a cobalt containing oxidation catalyst for use in the anode of the present invention comprises the addition of an at least about 3-fold stoichiometric excess of a reducing agent to an aqueous solution of a cobalt(II) compound in the presence of an electrically conductive carrier as set forth above. The stoichiometric excess of reducing agent will more often be at least about 10-fold, e.g., at least about 20-fold, at least about 30-fold, at least about 50-fold, or even at least about 60-fold, although it will usually not be higher than about 200-fold, e.g., not higher than about 100-fold.

The cobalt(II) compound can, for example, be a Co(II) complex, but will more often be a Co(II) salt of an inorganic acid or an organic acid (e.g., acetic acid), preferably an inorganic acid such as, e.g., hydrochloric acid, hydrobromic acid, sulfuric acid, nitric acid, and phosphoric acid. Co(II) nitrate is a particularly suitable compound for the purposes of the present invention. Of course, mixtures of different Co(II) salts (compounds) may also be used.

The concentration of the Co(II) compound in the aqueous solution prior to the addition of the reducing agent can be within a wide range. Preferably, the Co(II) compound is present in a concentration of at least about 0.01 molar, e.g., at least about 0.05 molar, but not higher than about 0.5 molar, e.g., not higher than about 0.1 molar.

The reducing agent can be any compound that is capable of reducing a Co(II) compound to metallic cobalt. Non-limiting examples thereof include hydrides such as NaBH₄, KBH₄, LiBH₄, (CH₃)₃NHBH₃, LiAlH₄, NaAlH₄, NaCNBH₃, CaH₂, LiH, NaH, KH, hydrazine, alkali and alkaline earth metal thiosulfates, sulfites, phosphites and hypophosphites and mixtures thereof. Currently preferred reducing agents comprise borohydride salts, in particular, alkali metal borohydrides such as, e.g., NaBH₄.

The reducing agent will usually be added as a solution in an aqueous solvent, preferably water. The pH of the solution will usually be at least about 9 and not higher than about 12. This pH depends to some extent on the pH of the aqueous solution of the Co(II) compound, and will usually be such that following the complete addition of the reducing agent, the pH of the resulting mixture is not lower than about 1, e.g., not lower than about 2, but usually not higher than about 12, e.g., not higher than about 11.

In order to adjust the pH of the solution of the reducing agent, the solution will usually contain a base, for example, an inorganic base such as NaOH, KOH or ammonia. The concentration of the reducing agent in the solution will usually be at least about 0.1 molar, e.g., at least about 0.2 molar, but usually not higher than about 1 molar, e.g., not higher than about 0.5 molar.

The reducing agent is added to the Co(II) containing solution preferably in a continuous fashion and at a rate which provides the desired small particle size. The rate of addition should also be sufficient to reduce already formed cobalt particles which have been oxidized on their surface by the oxygen present in the solution. This rate depends on, inter alia, the concentrations and the pH values of the solutions of the Co(II) compound and the reducing agent, the types of reducing agent and Co(II) compound employed, and the temperature at which the process is carried out. A suitable rate of addition can be determined by routine experimentation. The particle size of the formed cobalt particles (cobalt clusters) preferably is not higher than about 30 nm, e.g., not higher than about 20 nm, not higher than about 10 nm, not higher than about 5 nm, or not higher than about 2 nm.

The process of the present invention can be carried out over a wide temperature range. Best results are usually obtained with a temperature of at least about 10° C., e.g., at least about 20° C., but usually not higher than about 70° C., e.g., not higher than about 60° C.

Following the reduction process, the electrically conductive carrier (e.g., carbon) with the metallic cobalt deposited thereon will usually be filtered, rinsed with water and dried. The drying operation is carried out preferably at a temperature of at least about 60° C., e.g., at least about 80° C., but not higher than about 120° C., e.g., not higher than about 100° C. Drying times will usually range from about 0.5 hours to about 24 hours, mainly depending on the drying temperatures employed.

An anode for a fuel cell can be made from the cobalt containing oxidation catalyst of the present invention in a conventional manner well known to those skilled in the art. For example, a material comprising the cobalt oxidation catalyst of the present invention may, for example, be formed into a paste. The paste may be applied onto a suitable two-dimensional substrate (e.g., a sheet of paper or metal), and the substrate with the catalyst thereon may be brought into the desired shape and dimensions of the anode, optionally before or after reinforcement with, e.g., a metal grid or the like.

For forming the paste, the catalyst may be mixed with a liquid, e.g., water or a mixture thereof with a lower alcohol (such as, e.g., methanol, ethanol, propanol, isopropanol and butanol) and a suitable binder (such as, e.g., polytetrafluoroethylene).

The substrate may, for example, be carbon paper. The substrate with the catalyst paste thereon may be reinforced with a reinforcing element, e.g., a metal grid such as a nickel grid. A reinforcing element may be applied on one side or on both sides of the substrate. Also, two or more of the reinforced substrates may be combined, thereby forming sandwich or multilayer structures.

The material comprising the Co oxidation catalyst of the present invention may be employed as the anode of a liquid fuel cell. The cathode of the fuel cell may be any cathode that can be used in combination with a liquid fuel cell. Examples thereof are well known to those skilled in the art. Preferably, the cathode is an air-breathing cathode. Non-limiting examples thereof are a cathode comprising Pt on a electrically conductive carrier such as carbon and a cathode on the basis of a Co porphyrine catalyst (see Examples below).

The structure of a typical fuel cell according to the present invention comprises an anode which in its operative state is in contact with a liquid fuel on one side, and is in contact with a liquid electrolyte on its other side, and a cathode which also is in contact with the liquid electrolyte on one side thereof. The other side of the cathode is in contact with an oxidant, preferably oxygen, air or any other oxygen containing gas.

A liquid fuel for use in a fuel cell of the present invention may be any fuel that is suitable for liquid fuel cells. By way of non-limiting example, the liquid fuel may comprise a (monohydric or polyhydric) lower alcohol (usually a saturated aliphatic alcohol), optionally in combination with a solid fuel such as, e.g., LiAlH₄, KBH₄, NaBH₄, LiBH₄, (CH₃)₃NHBH₃, NaAlH₄, NaCNBH₃, CaH₂, LiH, NaH, KH, Na₂S₂O₃, Na₂HPO₃, Na₂HPO₂, K₂S₂O₃, K₂HPO₃, K₂HPO₂, NaCOOH, KCOOH or any combination of two or more thereof. The lower alcohol may, for example, be an alcohol having 1 to 6, e.g., 1 to 4 carbon atoms, and, 1 or more, e.g., 1 to 4, OH groups. Non-limiting examples thereof are methanol, ethanol, n-propanol, isopropanol, n-butanol, isobutanol, pentanol, hexanol, ethylene glycol, propylene glycol, glycerol, pentaerythritol and any combination of two or more thereof. The liquid fuel may also comprise a basic compound, e.g., for the purpose of stabilizing the solid fuel. The basic compound may be any suitable organic or inorganic base, for example, an inorganic hydroxide, non-limiting examples whereof are ammonium and (alkali and alkaline earth) metal hydroxides, such as, e.g., NaOH, KOH and LiOH, and NH₄OH.

A liquid electrolyte that is suitable for use in the a liquid fuel cell may comprise a base, for example an aqueous inorganic hydroxide. Non-limiting examples of the inorganic hydroxide are alkali metal hydroxides, such as, e.g., NaOH, KOH and LiOH. Non-limiting examples of liquid fuels and liquid electrolytes suitable for use in the fuel cell of the present invention are disclosed in U.S. Patent Application Publication Nos. 2002/0083640, 2002/0094459, 2002/0142196, in co-pending U.S. patent application Ser. No. 10/230,204, and U.S. Pat. Nos. 5,599,640 and 5,804,329, the entire disclosures whereof are hereby incorporated herein by reference.

The surface area of the anode (and of the cathode) of a fuel cell of the present invention is not particularly limited. Usually, however, the surface area is at least about 0.5 cm², e.g., at least about 2 cm², at least about 5 cm², at least about 10 cm², at least about 20 cm², or at least about 30 cm². On the other hand, the surface area usually is not larger than about 500 cm², e.g., not larger than about 300 cm², not larger than about 200 cm², not larger than about 100 cm², not larger than about 75 cm², or not larger than about 50 cm².

The liquid fuel cell of the present invention can be used to supply electrical energy to a virtually unlimited number of electric and electronic devices. Non-limiting examples thereof are (cellular) phones, (portable) computers, PDAs, consumer electronics, (portable) medical devices and components and peripherals thereof.

### BRIEF DESCRIPTION OF THE DRAWINGS

The present invention is further described in the detailed description which follows, in reference to the noted plurality of drawings by way of non-limiting examples of exemplary embodiments of the present invention. In the drawings:

FIG. 1 shows an ambient temperature CV(current-voltage)-curve of an anode (surface area 4 cm²) comprising a catalyst with 10% by weight of Co on carbon.

FIG. 2 shows an ambient temperature CV-curve of an anode (surface area 4 cm²) based on a 20% Co on carbon catalyst.

FIG. 3 shows an ambient temperature CV-curve of an anode (surface area 10 cm²) based on a 10% Co on carbon catalyst.

FIG. 4 shows ambient temperature dicharge (current and capacity) curves at a constant potential of 0.55 V for an alkaline fuel cell (surface area of anode 4 cm²) having Co based anode and cathode.

FIG. 5 shows ambient temperature dicharge (voltage and capacity) curves at a constant current of 0.5 A for an alkaline fuel cell (surface area of anode 4 cm²) having Co based anode and cathode.

FIG. 6 shows ambient temperature dicharge (current and capacity) curves at a constant power of 320 mW for an alkaline fuel cell (surface area of anode 4 cm²) having Co based anode and cathode.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

### EXAMPLE 1

(a) Preparation of Catalyst

Granulated carbon Vulcan XC-72 (Cabot Corp., 4.5 grams, specific surface area according to BET 254 m²/g) was placed in a beaker and intimately mixed with 100 ml of distilled water. The resultant dispersion was heated under reflux for 30 min. with vigorous stirring. Thereafter, it was cooled to 60° C., and a solution of Co(NO₃)₂×6H₂O (2.47 g in 25 ml of distilled water) was added thereto. The obtained mixture was stirred for 30 min at 60° C. and under vigorous stirring. Thereafter, a reducing agent for reducing the cobalt(II) ions to metallic cobalt was added at 60° C. The reducing agent was composed of NaBH₄ (5.23 g) and NaOH (0.37 g) dissolved in 500 ml of distilled water (pH=11.4).

The reducing agent was added by means of a TITRINO® apparatus [Metrohm UK, Ltd., Great Britain] at a feeding rate of the reducing agent of 20 ml/min. The rate of addition of the reducing agent must be controlled, because at too low an addition rate, already formed metal particles may get oxidized by the oxygen dissolved in the mixture. Also, the resultant particle size may not be in the desired range if the rate of addition is too low.

The pH during the reduction process reached a value of 11.1 and remained constant for 30 min at 60° C., which was considered an indication that the reduction process was completed.

The catalyst so obtained was filtered and rinsed with distilled water. Then the catalyst was dried for 12 hours in a vacuum furnace at 90° C. The catalyst weight after the completion of the above-described procedure was 5.0 g (10% Co+90% carbon).

(b) Manufacture and Testing of Anode

The catalyst from step (a) above (0.42 g) was wetted with 1.5 ml of water in order to reduce its pyrophoric properties. The wetted catalyst was homogenized by means of ultrasound for 6 min. Then an aqueous polytetrafluoroethylene (PTFE) dispersion (0.14 ml, 60% by weight of PTFE) was added thereto, and ultrasound homogenization was carried out for 6 min. About 1.5 ml of isopropyl alcohol was added to the resultant paste in order to increase the plasticity thereof.

Using a serigraphy-type method, the paste so obtained was applied at a layer thickness of about 0.20 mm onto carbon paper (B-2 Toray Carbon Paper TGPH-060, thickness 0.17 mm, surface area 42 cm²; E-TEK, Somerset, NJ, USA) which had been hydrophilized with polyvinyl alcohol. The thus coated paper was dried in ambient air for 30 min. and then for an additional 1.5 hours in a vacuum furnace at 90° C. Thereafter, two semi-finished products of the required dimensions (surface area 4 cm²) were cut out of the coated and dried carbon paper. A nickel grid of corresponding dimensions (NP-2, “Elecrocabel”, Kolchugino, Russia; wire diameter about 0.12 mm, average linear dimension of grid units about 0.2 mm) was placed between these two semi-finished products. In order to impart mechanical strength to the electrode, two additional nickel grids of corresponding dimensions were placed on both sides of this sandwich structure, and the resultant assembly was subjected to a pressure of 575 kg/cm² at a temperature of 70° C. to form an anode material. This anode material was glued onto a polyvinyl mandrel, and then it was placed in a fuel semi-cell. Thereafter, its electrochemical activity on the basis of the voltage-current and discharge characteristics in various modes was investigated. Voltage-current characteristics of the anode were obtained on a semi-cell having a fuel chamber volume of 20 ml, with a nickel plate being used as the counter-electrode (cathode). Electrolyte (6.6 M KOH, 5 ml) was placed between the anode and the counter-electrode. The semi-cell was connected to a MACCOR® measuring system (Maccor, Inc., Tulsa, Okla., USA).

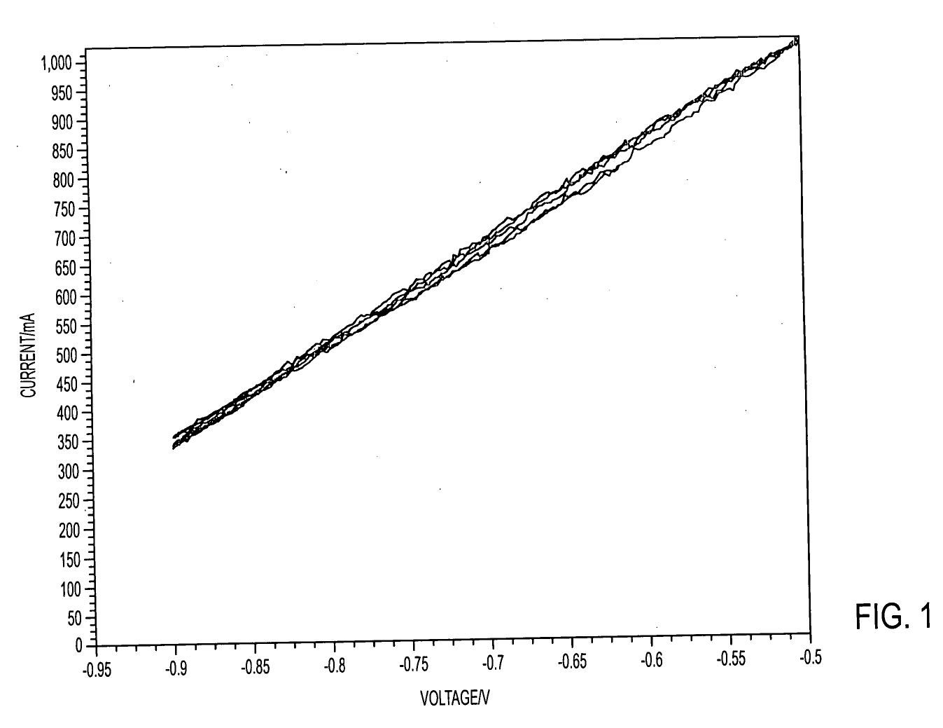

FIG. 1 shows typical voltage-current characteristics at ambient temperature of the anode so formed (surface area 4 cm²).

### EXAMPLE 2

The procedure of Example 1 was repeated, except that the catalyst contained 20 weight-% of cobalt and 80 weight-% of carbon (Vulkan XC-72). In this case, 4.0 gram of carbon were dispersed in 100 ml of water. After boiling and cooling to 60° C., 4.94 gram of Co(NO₃)₂×6H₂O, dissolved in 50 ml of distilled water (60° C.), was added to the dispersion. The addition rate of the reducing agent was 40 ml/min.; compositions and concentrations corresponded to those given in Example 1. Anode fabrication was performed as described in Example 1.

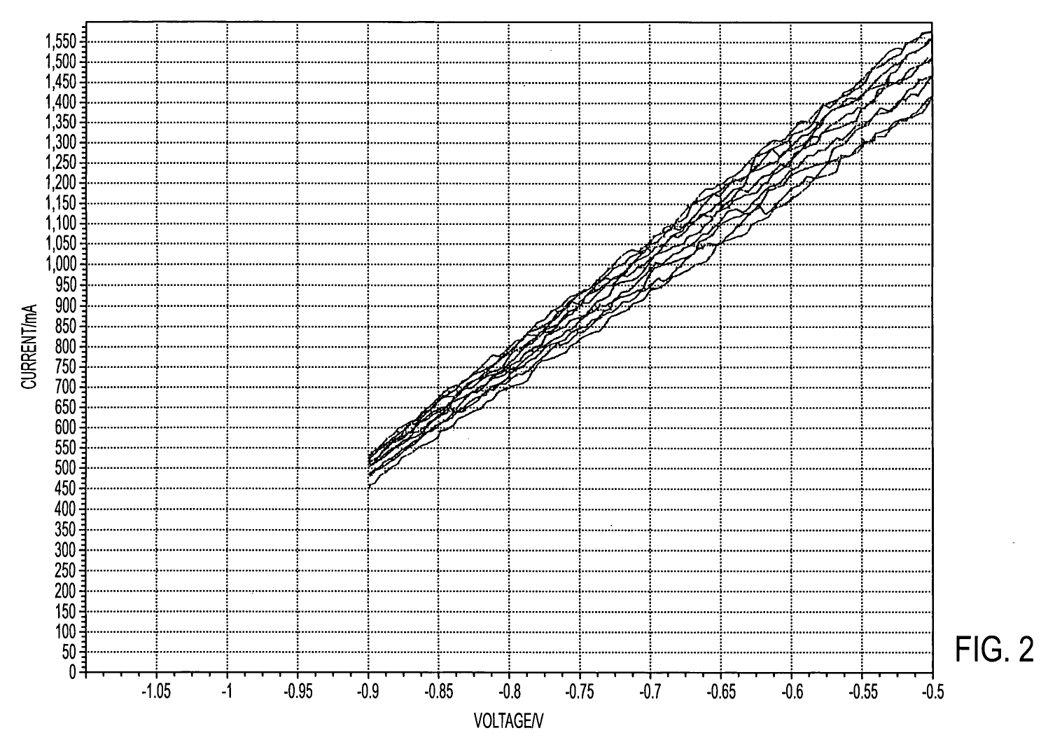

FIG. 2 shows the voltage-current characteristics at ambient temperature of the corresponding anode.

### EXAMPLE 3

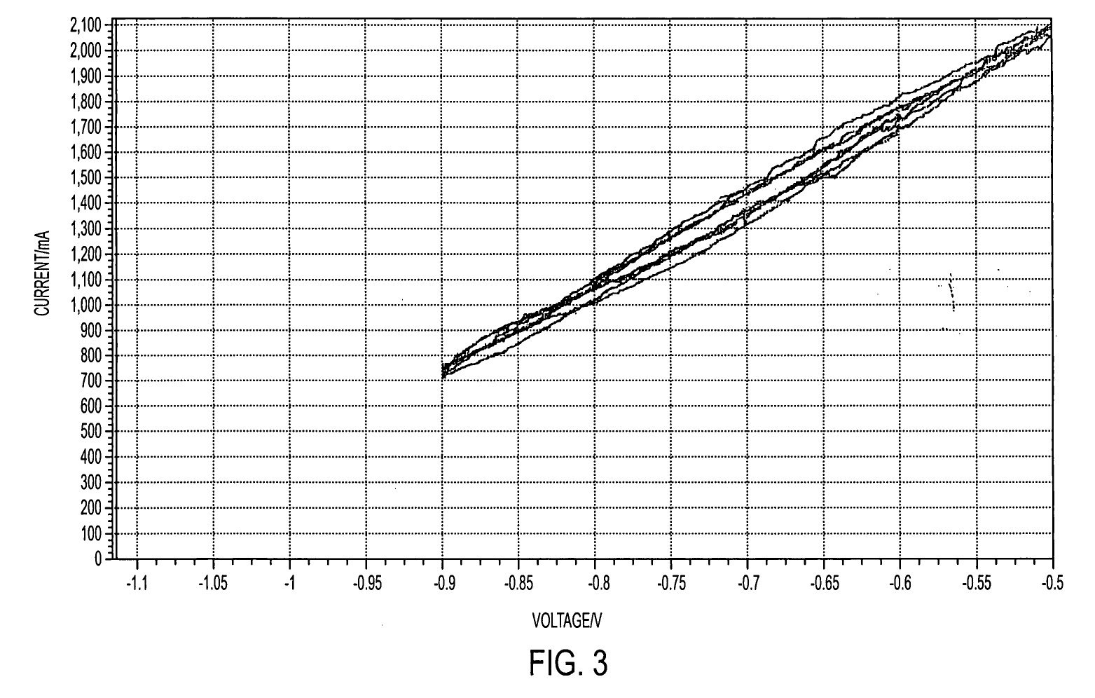

Example 1 was repeated, but the surface area of the anode was 10 cm² instead of 4 cm² as in Example 1. FIG. 3 shows the voltage-current characteristics at ambient temperature of the corresponding anode.

### EXAMPLE 4

The discharge characteristics of fuel cells comprising an anode according to the present invention were studied. The fuel elements used for these studies comprised a fuel tank (volume 17 cm³), two electrodes (anode and cathode, 4 cm² each) and an electrolyte chamber (6.6 M KOH, 5 ml) between them. The anodes were anodes fabricated according to Example 1. An air-breathing cathode was used as counter-electrode.

Specifically, the cathode was based on a Co porphyrine catalyst. This cathode may be prepared as follows: A mixture of 5-15 weight-% of Co-porphyrine (Aldrich) and 85-95 weight-% of carbon (Vulcan XC-72) is milled and thereafter subjected to pyrolysis in a nitrogen atmosphere for about 2 hours at 700-800° C. The resultant product is mixed with about 20-30 weight-% of aqueous PTFE dispersion (60 weight-% PTFE) and placed on a Ni grid as current collector. Thereafter a gas diffusion layer (SB carbon mixed with 20-40 weight-% of PTFE dispersion) is pressed on one side (the air-breathing side) of the resultant structure.

An alkaline aqueous solution (3.3 M KOH) containing 10 weight-% of glycerin and 12 weight-% of sodium borohydride was employed as fuel.

The discharge characteristics at ambient temperature of the fuel elements were obtained on a MACCOR® apparatus which allowed to study potentiostatic and galvanostatic discharge characteristics, as well as discharge at constant power (output).

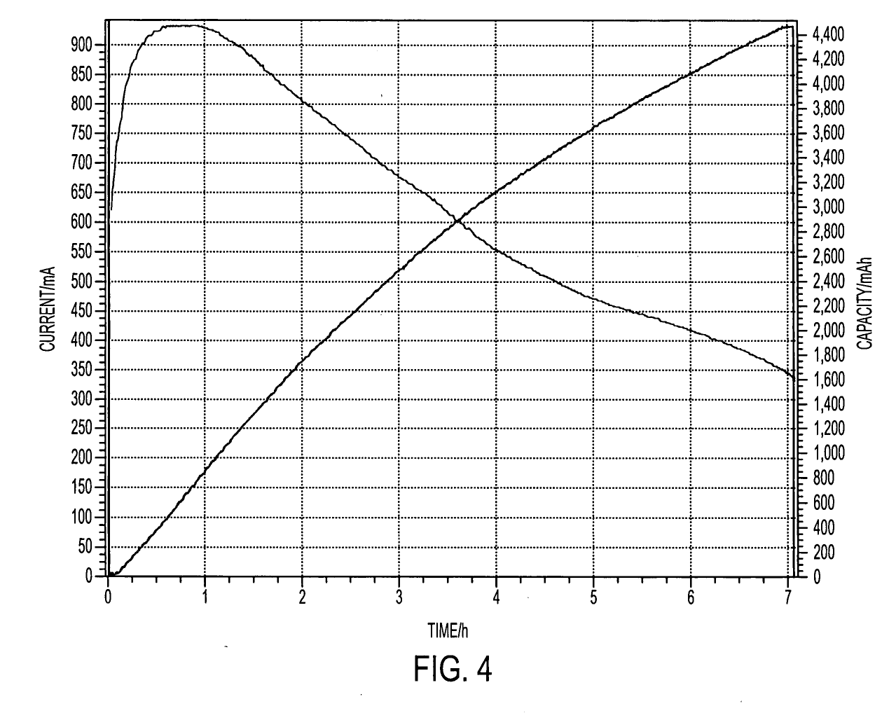

FIG. 4 is a graph showing the observed discharge characteristics of the fuel cell. The surface areas of the tested electrodes were 4 cm² each. Maximal discharge currents exceeded 900 mA (at a constant potential of −0.55 V), and the average output during 5 hours of operation was of the order of 100 mW. The discharge capacity over 6 hours of operation was at least 4,000 mAh.

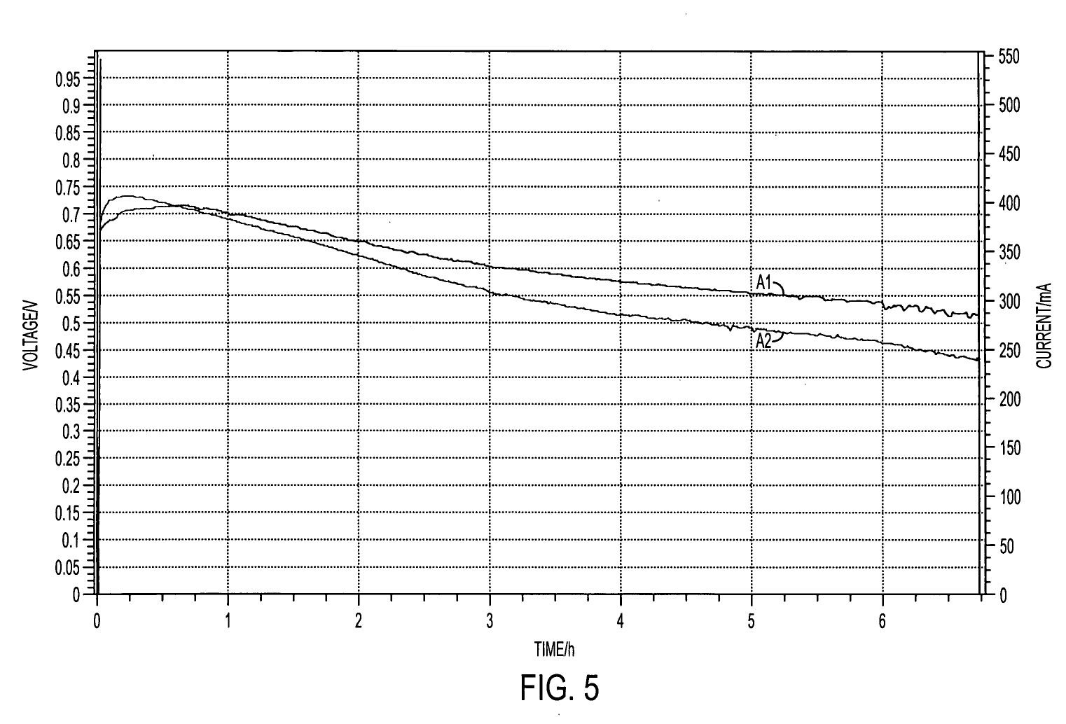

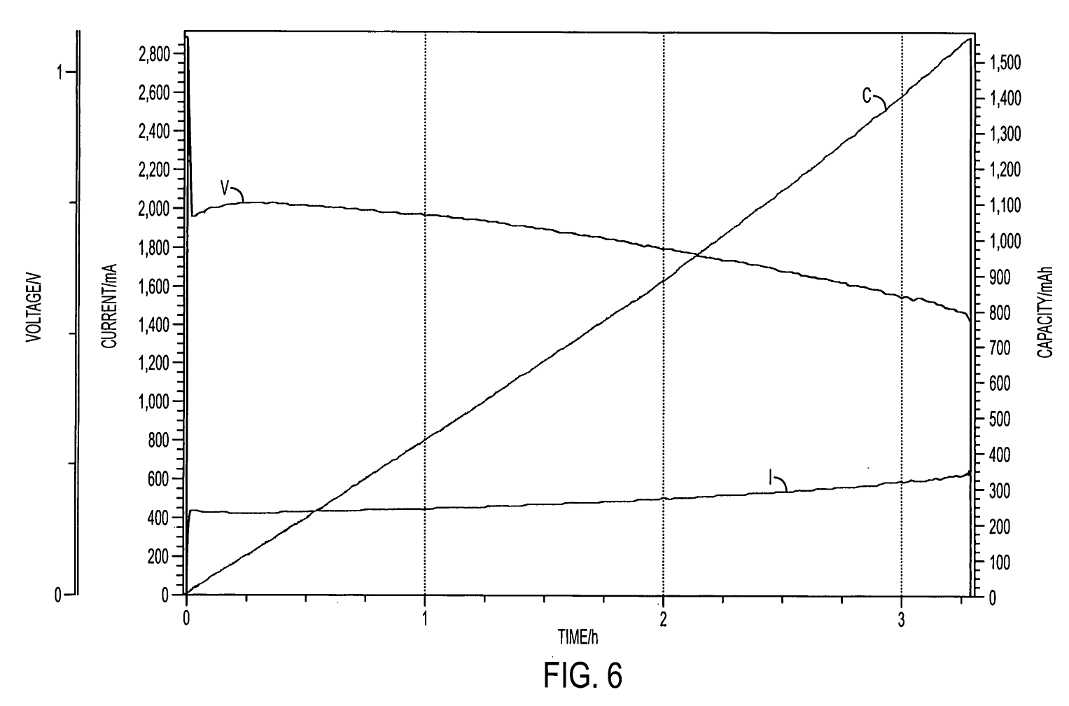

FIGS. 5 and 6 are graphs showing the galvanostatic discharge characteristics of the same fuel cell as above (at a constant current of 0.5 A), as well as the discharge characteristics at a constant output of 320 mW. These discharge characteristics were obtained after the cell had been discharged 12 times at a constant potential of −0.55 V.

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

1. An anode suitable for use in a liquid fuel cell, wherein the anode comprises metallic cobalt supported on a finely divided electrically conductive carrier.

2. The anode of claim 1, wherein the anode is substantially free of noble metals.

3. The anode of claim 2, wherein the anode further comprises up to a maximum of about 40% by weight of at least one additional metal, based on the combined weight of all metals present.

4. The anode of claim 3, wherein the at least one other metal comprises at least one of a transition metal and a rare earth metal.

5. The anode of claim 2, wherein the carrier comprises carbon.

6. The anode of claim 1, wherein the carrier has a specific surface area of at least about 20 m²/g.

7. The anode of claim 5, wherein the carrier has a particle size of not higher than about 30 μm.

8. The anode of claim 2, wherein the carrier has a particle size of not higher than about 20 μm.

9. The anode of claim 3, wherein the concentration of cobalt is from about 0.5 to about 40 weight percent, based on the combined weight of cobalt plus carrier.

10. The anode of claim 1, wherein the metallic cobalt comprises a cobalt containing alloy.

11. The anode of claim 10, wherein the cobalt containing alloy comprises at least about 1 mol-% of cobalt.

12. The anode of claim 11, wherein the cobalt containing alloy comprises one or more other metals selected from transition metals, rare earth metals, Al and Mg.

13. The anode of claim 1, wherein the anode is capable of providing, in an alkaline fuel cell, at least one of a current density of at least about 100 mA/cm² and a power of at least about 50 mW/cm² at a cathode/anode potential difference of 0.55 V and in a temperature range from about 10° C. to about 65° C.

14. The anode of claim 1, wherein the anode is capable of providing, in an alkaline fuel cell, a current density of at least about 200 mA/cm² and a power of at least about 70 mW/cm² at a cathode/anode potential difference of 0.55 V and in a temperature range from about 10° C. to about 65° C.

15. The anode of claim 13, wherein the anode has a surface area of about 0.5 cm² to about 200 cm².

16. A process for making an oxidation catalyst suitable for use in an anode for a liquid fuel cell, wherein the process comprises adding an at least about 3-fold stoichiometric excess of a reducing agent to an aqueous solution of a cobalt(II) compound in the presence of an electrically conductive carrier having a specific surface area of at least about 50 m²/g, at an addition rate of the reducing agent that provides an average particle size of the resultant metallic cobalt of not higher than about 30 nm.

17. The process of claim 16, wherein the cobalt(II) compound comprises Co(II) nitrate.

18. The process of claim 17, wherein the reducing agent comprises a borohydride salt.

19. The process of claim 18, wherein the borohydride salt comprises an alkali metal borohydride.

20. The process of claim 19, wherein the alkali metal comprises Na.

21. The process of claim 16, wherein the stoichiometric excess of the reducing agent is at least about 10-fold.

22. The process of claim 19, wherein the reducing agent is in the form of an aqueous solution.

23. The process of claim 22, wherein the solution has a pH of about 9 to about 12.

24. The process of claim 23, wherein the pH of the solution is such that a pH of a reaction mixture following the complete addition of the reducing agent is about 1 to about 12.

25. The process of claim 23, wherein the solution comprises an alkali metal hydroxide.

26. The process of claim 23, wherein a concentration of the reducing agent in the aqueous solution is about 0.1 to about 1 molar.

27. The process of claim 16, wherein the electrically conductive carrier comprises carbon.

28. The process of claim 27, wherein the carbon has a specific surface area of at least about 100 m²/g.

29. The process of claim 16, wherein the cobalt compound is present in the aqueous solution prior to adding the reducing agent at a concentration of from about 0.01 mol/l to about 0.5 mol/l.

30. The process of claim 17, wherein the electrically conductive carrier is present in an amount which results in a concentration of the cobalt of about 0.5 to about 40 weight percent, based on the combined weight of cobalt plus carrier.

31. The process of claim 16, wherein the process is carried out at a temperature of about 10° C. to about 70° C.

32. The process of claim 16, wherein the process is carried out in the substantial absence of noble metals.

33. The process of claim 32, wherein the process is carried out in the additional presence of a compound of at least one metal different from cobalt and the weight ratio of cobalt and the at least one metal different form cobalt is not lower than about 0.005:1.

34. The process of claim 31, wherein the process further comprises filtering the catalyst, rinsing it with water and drying it.

35. The process of claim 34, wherein the catalyst is dried at a temperature of about 60° C. to about 120° C.

36. The process of claim 35, wherein the catalyst is dried for about 0.5 hours to about 24 hours.

37. An oxidation catalyst suitable for use in an anode of a liquid fuel cell, obtainable by the process of claim 16.

38. An oxidation catalyst suitable for use in an anode of a liquid fuel cell, wherein the catalyst comprises metallic cobalt supported on an electrically conductive carrier having a specific surface area of at least about 20 m²/g in a concentration of the metallic cobalt of about 0.5 to about 40 weight percent, based on the combined weight of cobalt plus carrier.

39. The oxidation catalyst of claim 38, wherein the catalyst is substantially free of noble metals.

40. The oxidation catalyst of claim 39, wherein the catalyst further comprises up to a maximum of about 40% by weight of at least one additional metal, based on the combined weight of all metals present.

41. The oxidation catalyst of claim 40, wherein the at least one other metal comprises at least one of a transition metal and a rare earth metal.

42. The oxidation catalyst of claim 40, wherein the carrier comprises carbon.

43. The oxidation catalyst of claim 38, wherein the carrier has a particle size of not higher than about 30 μm.

44. A process for making an anode suitable for use in a liquid fuel cell, wherein the process comprises mixing the oxidation catalyst of claim 38, water, a lower alcohol and a binder to form a paste.

45. The process of claim 44, wherein the lower alcohol comprises isopropanol.

46. The process of claim 44, wherein the binder comprises polytetrafluoroethylene.

47. The process of claim 44, wherein the process further comprises applying the paste on carbon paper.

48. The process of claim 47, wherein the process further comprises combining the carbon paper with the paste thereon under pressure with a current collector.

49. The process of claim 48, wherein the current collector comprises a nickel grid.

50. A fuel cell comprising a cathode and an anode, wherein the anode comprises an oxidation catalyst comprising metallic cobalt supported on an electrically conductive carrier having a specific surface area of at least about 20 m²/g.

51. The fuel cell of claim 50 wherein the cobalt is present in a concentration of about 0.5 to about 40 weight percent, based on the combined weight of cobalt plus carrier.

52. The fuel cell of claim 51, wherein the oxidation catalyst is substantially free of noble metals.

53. The fuel cell of claim 52, wherein the oxidation catalyst further comprises up to a maximum of about 40% by weight of at least one additional metal, based on the combined weight of all metals present.

54. The fuel cell of claim 50, wherein the fuel cell further comprises at least one of a liquid fuel and a liquid electrolyte.

55. The fuel cell of claim 50, wherein the carrier has a specific surface area of at least about 50 m²/g.

56. The fuel cell of claim 50, wherein the cathode comprises an air-breathing cathode.

57. The fuel cell of claim 54, wherein the liquid fuel comprises a borohydride salt.

58. The fuel cell of claim 57, wherein the borohydride salt comprises an alkali metal borohydride.

59. The fuel cell of claim 58, wherein the alkali metal comprises Na.

60. The fuel cell of claim 54, wherein the liquid fuel comprises a solvent and an oxidizable material that is both dissolved and dispersed in the solvent.

61. The fuel cell of claim 60, wherein the solvent comprises water.

62. The fuel cell of claim 61, wherein the oxidizable material comprises at least one of LiAlH₄, NaBH₄, KBH₄, LiBH₄, (CH₃)₃NHBH₃, NaAIH₄, NaCNBH₃, CaH₂, LiH, NaH, KH, Na₂S₂O₃, Na₂HPO₃, Na₂HPO₂, K₂S₂O₃, K₂HPO₃, K₂HPO₂, NaCOOH and KCOOH.

63. The fuel cell of claim 61, wherein the oxidizable material comprises NaBH₄.

64. The fuel cell of claim 60, wherein the fuel further comprises an alcohol.

65. The fuel cell of claim 64, wherein the alcohol comprises at least one of methanol, ethanol, propanol, isopropanol, butanol, pentanol, hexanol, ethylene glycol, propylene glycol and glycerol.

66. The fuel cell of claim 64, wherein the alcohol comprises at least one of methanol and glycerol.

67. The fuel cell of claim 54, wherein the liquid electrolyte has a pH of higher than about 7.

68. The fuel cell of claim 67, wherein the liquid electrolyte comprises water and a basic compound.

69. The fuel cell of claim 68, wherein the basic compound comprises a hydroxide.

70. The fuel cell of claim 68, wherein the basic compound comprises an alkali metal hydroxide.

71. The fuel cell of claim 70, wherein the alkali metal comprises at least one of Na and K.

72. The fuel cell of claim 69, wherein the basic compound is present in a concentration of about 0.1 to about 5 mol/l.

73. An electrical device, wherein the device is in electrical contact with the fuel cell of claim 50.

74. A method of powering an electrical device, comprising establishing electrical contact between the device and the fuel cell of claim 50.
